(19) United States
(12) Patent Application Publication
(10) Pub. No.: US 2022/0383158 A1
(43) Pub. Date: Dec. 1, 2022

(54) METHOD FOR CLASSIFYING FAILURE CONSUMER DEVICES ON-LINE, ELECTRONIC DEVICE EMPLOYING METHOD, AND COMPUTER READABLE STORAGE MEDIUM

(71) Applicant: Fulian Precision Electronics (Tianjin) Co., LTD., Tianjin (CN)

(72) Inventors: FU-YUAN TAN, Taoyuan (TW); CHING-HAN CHENG, Taoyuan (TW)

(21) Appl. No.: 17/529,454

(22) Filed: Nov. 18, 2021

(30) Foreign Application Priority Data
May 25, 2021 (CN) 202110570010.9

(51) Int. Cl. G06N 5/04; G06N 20/00

(52) U.S. Cl. CPC G06N 5/04; G06N 20/00

(57) ABSTRACT

A method for classifying failures can determine consumer devices on-line as being repairable or not to be repaired. The method obtains a training set, the set including information as to total failure and information as to repairable failure. First key information in repairable failure and second key information in total failure are obtained. A first TF-IDF value of each first key information and a second TF-IDF value of each second key information are computed. A first feature bank is created based on the first TF-IDF value and a first threshold value, and a second feature bank is created based on the second TF-IDF value and a second threshold. Target failure is classified by the trained classifier. A failure classification is quickly achieved. An electronic device and a computer readable storage medium applying the method are also provided.

### FIELD

The subject matter herein generally relates to classification of failures in consumer devices, particularly to a method for classifying failures, an electronic device, and computer readable storage medium applying the method.

### BACKGROUND

Faulty electronic products after purchase are returned to manufacturer for checking, and for engineers to investigate why the device failed. When the failures are absolute, complete, and total, the device is not repaired. When the failure or faults are intermittent, such failure may be resolved by testing and repair. The detecting of faults operated by the engineers may have errors dues to many factors. The return process causes losses both in time and in cost. A depreciation risk and a commercial risk to the manufacturer with many faulty devices are increased.

Thus, there is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of an electronic device according to the present disclosure.

FIG. 2 is a flowchart illustrating an embodiment of method for classifying failures according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

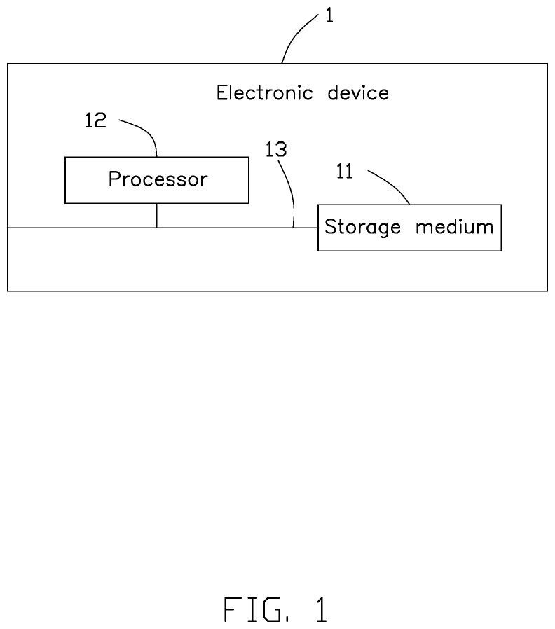

FIG. 1 shows an electronic device 1. The electronic device 1 includes a storage medium 11 and at least one processor 12, not being limited. The storage 11 and the at least one processor 12 communicate with each other through a communication bus or directly communicate with each other.

The electronic device 1 can be a computer, a mobile phone, a tablet, a personal digital assistant (PDA), and the like. The structure of the electronic device 1 as shown in FIG. 1 does not constitute a limitation on the electronic device 1, and the electronic device 1 may include more or fewer parts than that shown in the figure, or combine some parts, or have different arrangement of the parts. For example, the electronic device 1 also can include input output device, network device, and bus, and the like.

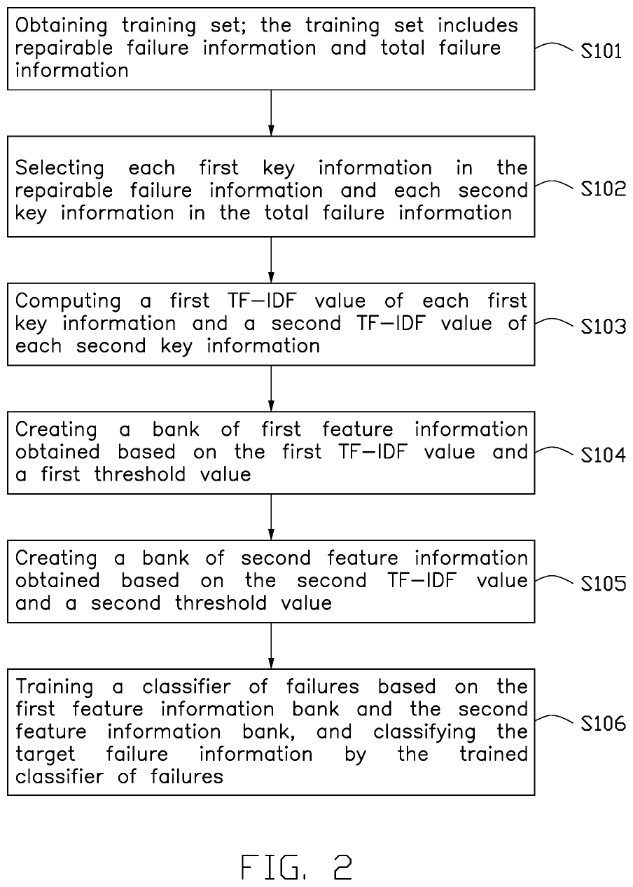

FIG. 2 shows a flowchart of a method for classifying failures in consumer devices (C-devices). Due to different requirements, a sequence of steps in the flowchart diagram can be changed, and some steps can be omitted. The method includes the following steps, these steps may be re-ordered:

In block S101, a training set is obtained. The training set includes a plurality of information as to failures which are total even when tested by engineers of the manufacturer (total failures) and a plurality of information as to failures or faults which are not total (repairable failures).

In one embodiment, when there is a total failure, a recorded state log data of a current server communicated with the C-device is recorded. The state log data includes data of the server. For example, if a blank screen appears while activating a C-device, and the blank screen remains when restarting the C-device, the blank screen is defined to indicate a total failure. Practically, when a number of failures exceeds a specified number, such as three times, the failure is considered as a total failure. When the failure is repairable, the recorded state log data of the current server is also recorded. The state log data includes data of the server. For example, when the C-device suddenly shuts down while using, but the C-device returns to normal by resetting the C-device, thus the shutting down failure is considered as a repairable failure. The number of the repairable failure is less than the specified number.

In one embodiment, a baseboard manager controller (BMC) is provided for obtaining state data of the running server. The state data can be a unique agent ID of a client in a local mode, a category of the running server, a severity of failure, a timestamp, a message, and a message ID. In one embodiment, the message ID serves as the state data. For example, SYS1003 represents a system CPU resetting.

In block S102, each first key information in the repairable failure information is selected, and each second key information in the total failure information is selected.

Practically, the data in each repairable failure and in each total failure information is large. There is representative data and there is unrepresentative data, but only the representative data need to be extracted.

In the embodiment, the message ID represents a severity of the failure. For example, levels of severity can include debugging, informational, warning, error, and critical. In one embodiment, the message ID with the critical level is selected. In detail, all the message IDs with the with the critical level in the repairable failure information are selected as the first key information. All the message IDs with the with the critical level in the total failure information are selected as the second key information.

In block S103, a first term frequency-inverse document frequency (TF-IDF) value of each first key information and a second TF-IDF value of each second key information are computed.

In the embodiment, the TF-IDF value is a normal weighting technology used in information and word searching. The TF-IDF value represents a severity of a word, to a file in a file set, or in terms. The larger the value of the TF-IDF, the more important the word will be, in the file set or the terms. The word has a good capacity in classification. The TF-IDF value is computed according to a formula of TF*IDF. TF is computed by a formula of

$$TF = \frac{{n}_{i , j}}{{\sum }_{1}^{k} {n}_{k , j}} .$$

n_{i,j} represents a number of times that the specified word appears in a file. Σ₁^{k}n_{k,j} represents a number of all the words in the file. IDF represents an inverse document frequency. IDF is computed by a formula of

$$IDF = log \frac{D}{T} .$$

D represents a number of the files. T represents a number of the files with the specified word.

In one embodiment, the step of the first TF-IDF value of the first key information being computed includes:

A number of first key information occurring in the repairable failure information t1 is obtained. An amount of the information in the repairable failure information d1 is obtained. The TF value of each first key information is computed, according a formula of t1/d1. A sum number of the repairable failure information and the total failure information D is computed. A number of the repairable failure information and the total failure information with the first key information T1 is computed. The IDF value of each first key information is computed, according to a formula of

$$log \frac{D}{T 1} .$$

The first TF-IDF value is computed based on the TF value and the IDF value of each first key information, according to the formula of

$$TF \times IDF = \frac{t 1}{d 1} \times log \frac{D}{T 1} .$$

In the present disclosure, the step of the first TF-IDF value of the first key information being computed includes:

A number of the second key information occurring in the repairable failure information t2 is obtained. An amount of the information in the repairable failure information d2 is obtained. The TF value of each second key information is computed, according the formula t2/d2. A sum number of the repairable failure information and the total failure information D is computed. A number of the repairable failure information and the total failure information with the second key information T2 is computed. The IDF value of each second key information is computed, according to the formula

$$log \frac{D}{T 2} .$$

The second TF-IDF value is computed based on the TF value and the IDF value of each second key information, according to the formula

$$TF \times IDF = \frac{t 2}{d 2} \times log \frac{D}{T 2} .$$

In block S104, a bank of first feature information obtained based on the first TF-IDF value and a first threshold value is created.

In the embodiment, the first threshold value is preset, and the first TF-IDF is compared with the first threshold value for selecting the first feature information of the repairable failure information.

In the embodiment, the step of creating a bank of first feature information being obtained based on the first TF-IDF value and a first threshold value includes: determining whether the first TF-IDF value is larger than the first threshold value. When the first TF-IDF value is found to be larger than the first threshold value, the first key information corresponding to the first TF-IDF value is confirmed as the first feature information of the repairable failure information for forming the first feature information bank.

In the embodiment, when the first TF-IDF value is found to be larger than the first threshold value, the frequency of the first key information occurring in the repairable failure information is high, and the frequency of the first key information occurring in the total failure information is low. Thus, the first TF-IDF value being larger than the first threshold value works to distinguish the repairable failure information from the total failure information.

In block S105, a bank of second feature information obtained based on the second TF-IDF value and a second threshold value is created.

In one embodiment, the second TF-IDF value corresponding to the second key information is compared with the second threshold value for selecting the second feature information of the total failure information.

In the embodiment, the step of creating a bank of second feature information being obtained based on the second TF-IDF value and a second threshold value includes: determining whether the second TF-IDF value is larger than the second threshold value. When the second TF-IDF value is found to be larger than the second threshold value, the second key information corresponding to the second TF-IDF value is confirmed as the second feature information of the total failure information for forming the second feature information bank.

In one embodiment, when the second TF-IDF value is found to be larger than the second threshold value, the frequency of the second key information occurring in the total failure information is high, and the frequency of the second key information occurring in the repairable failure information is low. Thus, the second TF-IDF value being larger than the second threshold value works to distinguish the total failure information from the repairable failure information.

In block S106, a classifier of failures is trained based on the first feature information bank and the second feature information bank, and the trained classifier of failures classifies target failure information.

The failure is classified by the classifier of failures.

In one embodiment, the step of a classifier of failures being trained based on the first feature information bank and the second feature information bank includes: a first number of feature information being obtained from the first feature information bank and the second feature information bank in a first specified ratio, which serves as target training data. The target training data is inputted into a specified neural network frame for training to obtain the classifier of failures. The neural network frame includes a KERAS frame and a TENSORFLOW frame. A second number of the feature information is obtained from the first feature information bank and the second feature information bank in a second specified ratio, which serves as target testing data. The classifier of failures is tested based on the target testing data to obtain a testing ratio. When the testing ratio is larger than a specified threshold value, the classifier of failures is considered as a target classifier of failures. When the testing ratio is less than the specified threshold value, the amount of target training data is increased, and the classifier of failures is re-trained by the increased target training data, until the testing ratio is larger than the specified threshold ratio.

In one embodiment, an updating period is set, the classifier of failures is re-trained after each updating period.

In one embodiment, the step of the trained classifier of failures classifying target failure information includes: extracting a plurality of third key information from target failure information. A third TF-IDF value of each third key information is computed. A determination is made as to whether the third TF-IDF value is larger than a third threshold value. When the third TF-IDF value is found to be larger than the third threshold value, the third TF-IDF value corresponding to the third key information serves as the third feature information of the target failure information. The trained classifier of failures classifies failures based on the third feature information.

By training a failure classify model with a TF-IDF algorithm, the failure classify model has a generalization feature and can be used in different C-devices. Other C-devices need to construct a recurred or un-recurred classify model, where only the data of the C-device is provided to the failure classify model. Thus, the failure classify model with a TF-IDF algorithm can classify the failure into either a recurred category or an un-recurred category.

After the step of block S106, the method further includes determining whether failure information is loaded on a cloud platform. When failure information is being loaded, the failure information is transferred to a local database through a Restful application interface. When the failure information is written into the local database, the trained classifier of failures classifies the target failure information to obtain a prediction value. The prediction value is written into the local database and is transferred to the cloud platform through the Restful application interface for displaying.

Referring to FIG. 1, the storage medium 11 is an internal storage of the electronic device 1, which is embedded in the electronic device 1. In other embodiments, the storage medium 11 can be an external storage medium 11, which is coupled to the electronic device 1.

In some embodiments, the storage medium 11 stores program codes and various data. The storage medium 11 realizes high speed and automatic access of the program or data during operations on the electronic device 1.

The storage medium 11 can be a random-access storage medium, or a non-volatile storage, such as a hard disk, a memory, a plug-in hard disk, a smart media card (SMC), a secure digital (SD), a flash card, a disk storage component, a flash component, or other volatile solid memory.

In one embodiment, the processor 12 can be a central processing unit (CPU), or other universal processor, such as a digital signal process (DSP), an application specific integrated circuit (ASIC), a field-programmable gate array (FPGA), or other programmable logic component, discrete gate or transistor logic, discrete hardware components, and so on. The universal processor can be a microprocessor or the at least one processor can be any regular processor, or the like.

If the modules/units of the storage medium 11 are implemented in the form of or by means of a software functional unit installed in independent or standalone product, all parts of the integrated modules/units of the storage unit may be stored in a computer-readable storage medium. One or more programs are used to control the related hardware to accomplish all or parts of the methods of this disclosure. The one or more programs can be stored in a computer-readable storage medium. The one or more programs can accomplish the step of the exemplary method when executed by the at least one processor 12. The program codes can be in the form of source code, object code, executable code file, or in some intermediate form. The computer-readable storage medium may include any entity or device capable of carrying the program codes, recording media, USB flash disk, mobile hard disk, disk, computer-readable storage medium, read-only memory, and the like.

Division of the modules is only a logical function division, and other division manners may be adopted during practical implementation. Each function module in each embodiment of the present disclosure may be integrated into a processing module, each module may also exist independently and physically, and two or more than two modules may also be integrated into a module. The above-mentioned integrated module may be implemented in a form of hardware and may also be implemented in forms of hardware and software function module.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for classifying failure, applicable in an electronic device; the electronic device comprises a non-transitory storage medium with program codes and a processor; the processor executes the program codes in the non-transitory storage medium to implement the method; the method comprises:
obtaining training set; the training set comprises repairable failure information and total failure information;
selecting each first key information in the repairable failure information and each second key information in the total failure information;
computing a first term frequency-inverse document frequency (TF-IDF) value of each first key information and a second TF-IDF value of each second key information;
creating a bank of first feature information obtained based on the first TF-IDF value and a first threshold value;
creating a bank of second feature information obtained based on the second TF-IDF value and a second threshold value; and
training a classifier of failures based on the first feature information bank and the second feature information bank and classifying target failure information by the trained classifier of failures.

2. The method of claim 1, wherein the step of selecting each first key information in the repairable failure information and each second key information in the total failure information comprises:
selecting first critical level failure information from the repairable failure information as the first key information based on a severity level of the repairable failure information; and
selecting second critical level failure information from the total failure information as the second key information based on a severity level of the total failure information.

3. The method of claim 1, wherein the step of creating a bank of first feature information obtained based on the first TF-IDF value and a first threshold value comprises:
determining whether the first TF-IDF value is larger than the first threshold value;
confirming the first key information corresponding to the first TF-IDF value as the first feature information of the repairable failure information; and
creating the first feature information bank based on the first feature information.

4. The method of claim 3, wherein the step of creating a bank of second feature information obtained based on the second TF-IDF value and a second threshold value comprises:
determining whether the second TF-IDF value is larger than the second threshold value;
confirming the second key information corresponding to the second TF-IDF value as the second feature information of the total failure information; and
creating the second feature information bank based on the second feature information.

5. The method of claim 4, wherein the step of training a classifier of failures based on the first feature information bank and the second feature information bank comprises:
obtaining a first number of feature information from the first feature information bank and the second feature information bank in a first specified ratio as target training data;
inputting target training data into a specified neural network frame for training to obtain the classifier of failures; the neural network frame comprises a KERAS frame and a TENSORFLOW frame;
obtaining a second number of feature information from the first feature information bank and the second feature information bank in a second specified ratio as target testing data; and
testing the classifier of failures based on the target testing data to obtain a testing ratio; and
confirming the classifier of failures as a target classifier of failures when the testing ratio is larger than the specified threshold value.

6. The method of claim 5, wherein the method further comprises:
extracting third key information in target failure information;
computing a third TF-IDF value of each third key information;
determining whether the third TF-IDF value is larger than a third threshold value;
confirming the third key information corresponding to the third TF-IDF value as the third feature information of the target failure information; and
classifying the target failure information by the trained classifier of failures based on the third key information.

7. The method of claim 1, wherein the method further comprises:
determining whether failure information is loaded on a cloud platform;
transferring failure information to a local database through a Restful application interface when the failure information is loaded on the cloud platform;
writing the failure information into the local database and classifying the failure information to obtain a prediction value;
writing the prediction value into the local database; and
transferring prediction value to the cloud platform through the Restful application interface to be displayed on the cloud platform.

8. The method of claim 1, wherein the method further comprises:
setting an updating period; and
re-training the classifier of failures after each updating period.

9. An electronic device comprises a non-transitory storage medium with program codes, which when being executed by a processor, cause the processor to:
obtain training set; the training set comprises repairable failure information and total failure information;
select each first key information in the repairable failure information and each second key information in the total failure information;
compute a first term frequency-inverse document frequency (TF-IDF) value of each first key information and a second TF-IDF value of each second key information;
create a bank of first feature information obtained based on the first TF-IDF value and a first threshold value;
create a bank of second feature information obtained based on the second TF-IDF value and a second threshold value; and
train a classifier of failures based on the first feature information bank and the second feature information bank and classify target failure information by the trained classifier of failures.

10. The electronic device of claim 9, wherein the processor to select each first key information in the repairable failure information and each second key information in the total failure information comprises:
select first critical level failure information from the repairable failure information as the first key information based on a severity level of the repairable failure information; and
select second critical level failure information from the total failure information as the second key information based on a severity level of the total failure information.

11. The electronic device of claim 9, wherein the processor to create a bank of first feature information obtained based on the first TF-IDF value and a first threshold value comprises:
determine whether the first TF-IDF value is larger than the first threshold value;
confirm the first key information corresponding to the first TF-IDF value as the first feature information of the repairable failure information; and
create the first feature information bank based on the first feature information.

12. The electronic device of claim 11, wherein the processor to create a bank of second feature information obtained based on the second TF-IDF value and a second threshold value comprises:
determine whether the second TF-IDF value is larger than the second threshold value;
confirm the second key information corresponding to the second TF-IDF value as the second feature information of the total failure information; and
create the second feature information bank based on the second feature information.

13. The electronic device of claim 12, wherein the process to train a classifier of failures based on the first feature information bank and the second feature information bank comprises:
obtain a first number of feature information from the first feature information bank and the second feature information bank in a first specified ratio as target training data;
input target training data into a specified neural network frame for training to obtain the classifier of failures; the neural network frame comprises a KERAS frame and a TENSORFLOW frame;
obtain a second number of feature information from the first feature information bank and the second feature information bank in a second specified ratio as target testing data; and
test the classifier of failures based on the target testing data to obtain a testing ratio; and
confirm the classifier of failures as a target classifier of failures when the testing ratio is larger than the specified threshold value.

14. The electronic device of claim 13, wherein the processor further:
extract third key information in target failure information;
compute a third TF-IDF value of each third key information;
determine whether the third TF-IDF value is larger than a third threshold value;
confirm the third key information corresponding to the third TF-IDF value as the third feature information of the target failure information; and
classify the target failure information by the trained classifier of failures based on the third key information.

15. The electronic device of claim 1, wherein the processor further:
determine whether failure information is loaded on a cloud platform;
transfer failure information to a local database through a Restful application interface when the failure information is loaded on the cloud platform;
write the failure information into the local database and classify the failure information to obtain a prediction value;
write the prediction value into the local database; and
transfer prediction value to the cloud platform through the Restful application interface to be displayed on the cloud platform.

16. The electronic device of claim 9, wherein the processor further:
set an updating period; and
re-train the classifier of failures after each updating period.

17. A computer readable storage medium stores program codes; the program codes are executed by at least one processor to implement the following steps:
obtaining training set; the training set comprises repairable failure information and total failure information;
selecting each first key information in the repairable failure information and each second key information in the total failure information;
computing a first term frequency-inverse document frequency (TF-IDF) value of each first key information and a second TF-IDF value of each second key information;
creating a bank of first feature information obtained based on the first TF-IDF value and a first threshold value;
creating a bank of second feature information obtained based on the second TF-IDF value and a second threshold value; and
training a classifier of failures based on the first feature information bank and the second feature information bank, and classifying target failure information by the trained classifier of failures.

18. The computer readable storage medium of claim 17, wherein the step of selecting each first key information in the repairable failure information and each second key information in the total failure information comprises:
selecting first critical level failure information from the repairable failure information as the first key information based on a severity level of the repairable failure information; and
selecting second critical level failure information from the total failure information as the second key information based on a severity level of the total failure information.

19. The computer readable storage medium of claim 18, wherein the step of creating a bank of second feature information obtained based on the second TF-IDF value and a second threshold value comprises:
determining whether the first TF-IDF value is larger than the first threshold value;
confirming the first key information corresponding to the first TF-IDF value as the first feature information of the repairable failure information; and
creating the first feature information bank based on the first feature information.

20. The computer readable storage medium of claim 19, wherein the step of training a classifier of failures based on the first feature information bank and the second feature information bank, and classifying target failure information by the trained classifier of failures comprises:
obtaining a first number of feature information from the first feature information bank and the second feature information bank in a first specified ratio as target training data;
inputting target training data into a specified neural network frame for training to obtain the classifier of failures; the neural network frame comprises a KERAS frame and a TENSORFLOW frame;
obtaining a second number of feature information from the first feature information bank and the second feature information bank in a second specified ratio as target testing data; and
testing the classifier of failures based on the target testing data to obtain a testing ratio; and
confirming the classifier of failures as a target classifier of failures when the testing ratio is larger than the specified threshold value.
